(19) United States
(12) Patent Application Publication
(10) Pub. No.: US 2007/0069980 A1
(43) Pub. Date: Mar. 29, 2007

(54) Method and sysem for estimating nosie in video data

(76) Inventor: Alexander MacInnis, Lake Oswego, OR (US)

Correspondence Address: MCANDREWS HELD & MALLOY, LTD, 500 WEST MADISON STREET, SUITE 3400, CHICAGO, IL, 60661, US

(21) Appl. No.: 11/485,665

(22) Filed: Jul. 13, 2006

Related U.S. Application Data
(60) Provisional application No. 60/701,177, filed on Jul. 18, 2005.
(60) Provisional application No. 60/701,179, filed on Jul. 18, 2005.
(60) Provisional application No. 60/701,181, filed on Jul. 18, 2005.
(60) Provisional application No. 60/701,180, filed on Jul. 18, 2005.
(60) Provisional application No. 60/701,178, filed on Jul. 18, 2005.
(60) Provisional application No. 60/701,182, filed on Jul. 18, 2005.

(51) Int. Cl. G09G 3/20

(52) U.S. Cl. 345/58

(57) ABSTRACT

Described herein are a method and a system for noise estimation. The method and system produce a noise level estimate based a plurality of residual values. A residual value may be the difference between a pixel that is in a location in one picture and another pixel that is in the same location of another picture. If all of the residual values in a window have a magnitude within a range, those residual values are compared to one or more thresholds. The noise estimate may be calculated based on the comparison results. The method and system may be incorporated into video processing applications. For example, the proper identification of the noise level may aid motion estimators used in video coding; motion compensated temporal filtering; and aid in controlling adaptive filters.

### RELATED APPLICATIONS

This application claims priority to METHOD AND SYSTEM FOR ESTIMATING NOISE IN VIDEO DATA, Provisional Application for U.S. Patent, Ser. No. 60/701,177, filed Jul. 18, 2005, by MacInnis, which is incorporated by reference herein for all purposes.

This application is related to the following applications, each of which is hereby incorporated herein by reference in its entirety for all purposes:

U.S. Provisional Patent Application Ser. No. 60/701,179, METHOD AND SYSTEM FOR NOISE REDUCTION WITH A MOTION COMPENSATED TEMPORAL FILTER, filed Jul. 18, 2005 by MacInnis;

U.S. Provisional Patent Application Ser. No. 60/701,181, METHOD AND SYSTEM FOR MOTION COMPENSATION, filed Jul. 18, 2005 by MacInnis;

U.S. Provisional Patent Application Ser. No. 60/701,180, METHOD AND SYSTEM FOR VIDEO EVALUATION IN THE PRESENCE OF CROSS-CHROMA INTERFERENCE, filed Jul. 18, 2005 by MacInnis;

U.S. Provisional Patent Application Ser. No. 60/701,178, METHOD AND SYSTEM FOR ADAPTIVE FILM GRAIN NOISE PROCESSING, filed Jul. 18, 2005 by MacInnis;

U.S. Provisional Patent Application Ser. No. 60/701,182, METHOD AND SYSTEM FOR MOTION ESTIMATION, filed Jul. 18, 2005 by MacInnis; and

U.S. patent application Ser. No. 11/314,680, METHOD AND SYSTEM FOR CONTENT ADAPTIVE ANALOG VIDEO NOISE DETECTION, filed Dec. 20, 2005 by Zhong et al.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for noise estimation in a video sequence, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a flow diagram of an exemplary method for noise estimation in accordance with an embodiment of the present invention;

FIG. 2 is a block diagram of an exemplary system for noise estimation in accordance with an embodiment of the present invention;

FIG. 3 is a graph describing the cumulative distribution of unsigned noise samples in accordance with an embodiment of the present invention;

FIG. 4 is a graph describing a relationship between precision and accuracy for estimating noise power in accordance with an embodiment of the present invention;

FIG. 5 is a graph describing the distribution of noise samples in a small sample set in accordance with an embodiment of the present invention;

FIG. 6 is a block diagram of an exemplary motion compensated temporal filter in accordance with an embodiment of the present invention; and

FIG. 7 is a picture of an exemplary video display device in accordance with an embodiment of the present invention.

### DETAILED DESCRIPTION OF THE INVENTION

Described herein are a method and a system for noise estimation. The method and system produce a noise level estimate based on a plurality of residual values.

A residual value may be produced by taking the difference between a pixel that is in a location of one picture and another pixel that is in the same location of another picture. A “window” is an array of sample locations used for measurement purposes. If all of the residual values in a measurement window are within a predetermined range, those residual values are compared to one or more thresholds. The noise estimate may be calculated based on the comparison results. The method and system may be incorporated into video processing applications. For example, the proper identification of the noise level may aid motion estimators used in video coding and motion compensated temporal filtering, and it may aid in controlling video filters.

The metrics utilized in certain embodiments of the present invention may be combined by the system(s), method(s), or apparatus described in METHOD AND SYSTEM FOR MOTION COMPENSATION, Ser. No. 60/701,181, filed Jul. 18, 2005 by MacInnis, and incorporated herein by reference for all purposes.

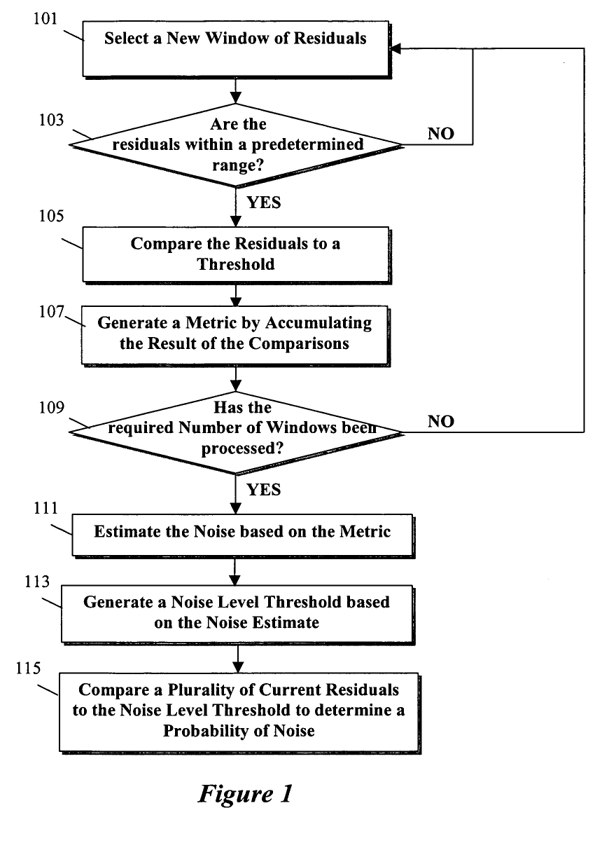

FIG. 1 is a flow diagram for estimating noise in accordance with an embodiment of the present invention. A window of residuals is selected for analysis at 101.

The residuals in the window are compared to a predetermined range at 103. Alternatively, unsigned residual values may be computed as the absolute value of the residuals. If the magnitude of any residual is greater than a maximum residual level, a new window of residuals is selected at 101.

If the residuals are within the predetermined range, the residuals are then compared to a threshold at 105, and the number of residuals that have a magnitude greater than the threshold is accumulated. The threshold may be based on candidate noise levels. For example, a candidate noise level may have an associated standard deviation (σ) on which a threshold may be determined.

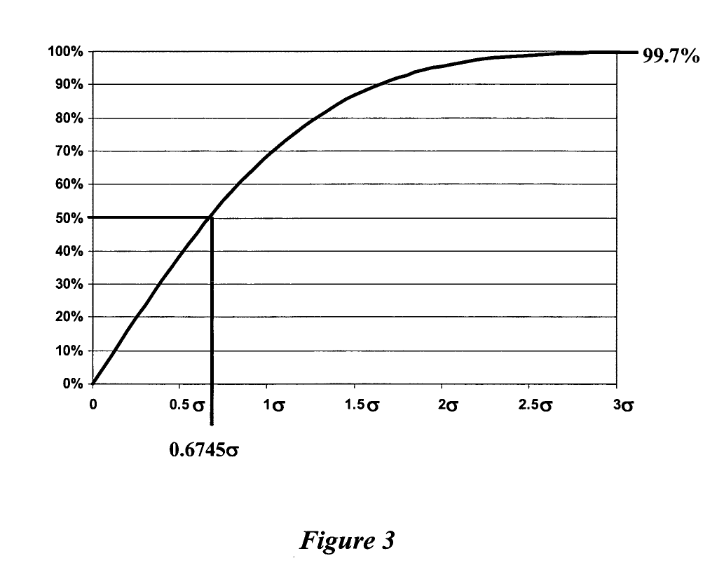

In FIG. 3, a graph illustrates the cumulative distribution of the absolute values of noise samples that are Gaussian distributed with a mean of zero and a standard deviation of σ. 50% of the unsigned samples may fall below (or above) a threshold of 0.6745σ. The maximum residual level may be set to 2σ or more resulting in less than 5% of the noise samples being excluded from analysis.

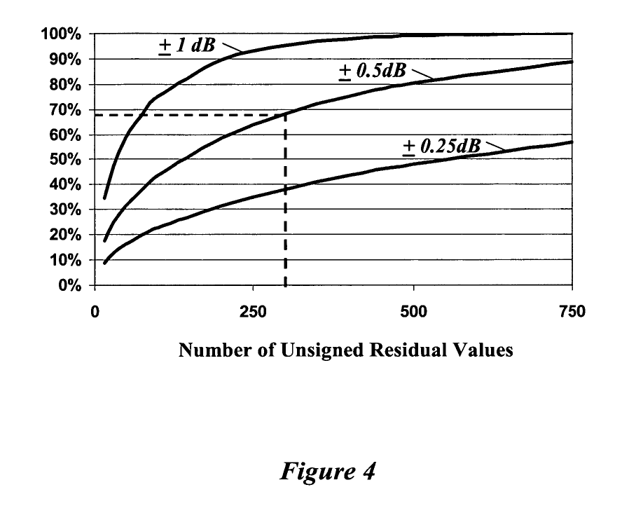

The statistics of noise characterization is such that many samples are taken to ensure accuracy. FIG. 4 shows a graph that describes a relationship between precision and accuracy for estimating noise power in accordance with an embodiment of the present invention. Given a number of noise samples, the percentage of time that noise estimation is accurate to ±0.25 dB, ±0.5 dB, and ±1 dB may be shown. For example if 300 residuals are processed, the noise estimate may be accurate to the nearest 1 dB (i.e. ±0.5 dB) 65-75% of the time. A window may be considered static if the residual values fall below the maximum value. For randomly selected video sequences, a static 300-pixel window of residuals may not occur very often. The 300 residuals may, for example, be found in 20 windows of size 3×5.

Turning back to FIG. 1, one or more metrics are generated at 107 by accumulating the results of the comparisons in 105. When the number of residuals to meet an accuracy requirement is distributed over multiple windows, the number of windows processed is monitored at 109. If more residuals are required, a new window of residuals is selected at 101. If enough residuals have been processed, the noise is estimated at 111 based on the metric(s). The noise level estimate may be interpolated from two noise levels based on the proximity of the two associated metrics to predetermined metric values.

Once noise has been estimated, a smaller set of residuals may be processed to determine the probability that noise of the estimated level is predominate. At 113, a third threshold is generated based on the noise level estimate found at 111. The threshold may represent the median value of the estimated noise level.

At 115, a plurality of current residuals is compared to the threshold generated at 113. The difference between the number of residual values to either side of the threshold (\hat{p}) in the window (of size N) can be compared to half the window size (N/2) to determine a probability of noise: prob(noise)=f(|\hat{p}_{N}−N/2)|

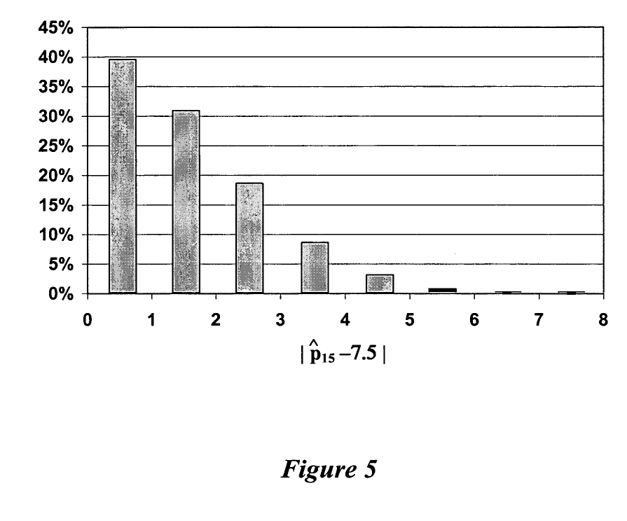

FIG. 5 is a graph describing the distribution of noise samples in a small sample set in accordance with an embodiment of the present invention. For illustrative purposes, 15 residual values are compared to a threshold based on the estimated noise. If 7 or 8 residual values out of 15 are greater than (or less than) the threshold, noise of the estimated level may be considered likely. If more than 12 or less than 4 residual values out of 15 are greater than (or less than) the threshold, noise of the estimated level may be considered unlikely. It should be obvious that other window sizes may also be utilized.

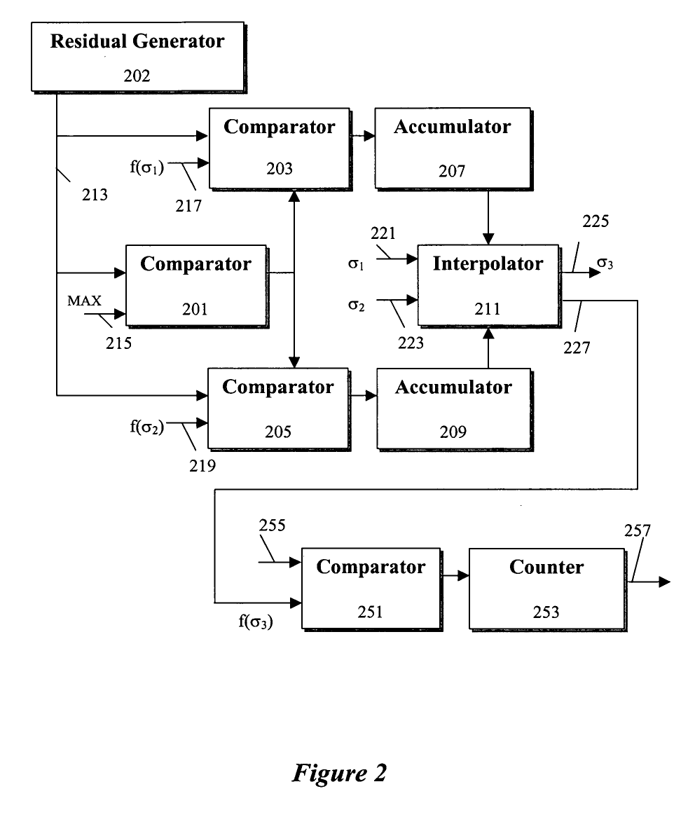

FIG. 2 is a block diagram of an exemplary system for noise estimation in accordance with an embodiment of the present invention.

The comparators 201, 203, 205, and 251 may be code, logic, and/or circuitry that enables the comparison of two inputs and generate a output equal to one or zero according to a comparison function. The comparison function may be “less than or equal to”, “greater than or equal to”, “less than”, or “greater than”.

The accumulators 207, 209, and 253 may be code, logic, and/or circuitry that sum an input value.

A residual generator 202 may produce a difference between a first pixel in a first picture and a second pixel in a second picture, thereby generating a residual value 213. The residual value 213 may be signed or unsigned. For example, a signed residual value may be compared to an upper threshold and a lower threshold, thereby determining whether the signed residual value falls within a range. Alternatively, an unsigned residual value may be compared to a single threshold. For illustrative purposes, the system utilizing an unsigned residual value will be further described.

A first comparator 201 receives a plurality of unsigned residual values 213 and determines if the unsigned residual values are all “less than” the maximum residual level 215.

If the unsigned residual values (or a windowed subset thereof) are determined to be less than the maximum residual level 215, a comparator 203 may compare the plurality of unsigned residual values to a threshold 217 that is based on a first noise level, and a comparator 205 may compare the plurality of unsigned residual values to a threshold 219 that is based on a second noise level. The comparison may be “less than or equal to”, “greater than or equal to”, “less than”, or “greater than”.

Accumulators 207 and 209 sum the respective results of the comparators 203 and 205. A noise level estimate 225 may be based on one or more accumulator outputs. The noise level estimate may be the interpolation (or extrapolation) between the first noise level 221 and the second noise level 223 based on the proximity of the first metric and the second metric to one or more predetermined metric values. For example if the thresholds 217 and 219 are based on a theoretical median, the noise estimate level 225 is weighted more heavily by the accumulator output that is closer to 50% of the sample size. The sample size is the number of residual values in the analyzed subsets (i.e. windows).

Once the noise estimate 225 is determined, a comparator 251 may compare a new set of unsigned residual values 255 to a noise level threshold 227. A counter 253 generates a metric 257 that indicates a presence of noise in the plurality of current unsigned residual values as described in reference to FIG. 5.

A Motion Compensated Temporal Filter (MCTF) may apply motion compensation prior to filtering in the time domain. Accurate estimation of noise may allow the MCTF processing to better optimize the settings of functions within the MCTF, to maximize video quality. If the difference between the residual associated with a candidate motion vector and the residual associated with a zero vector (i.e. no motion) is comparable to the noise estimate, motion may not be distinguishable from noise, and the confidence may be lowered.

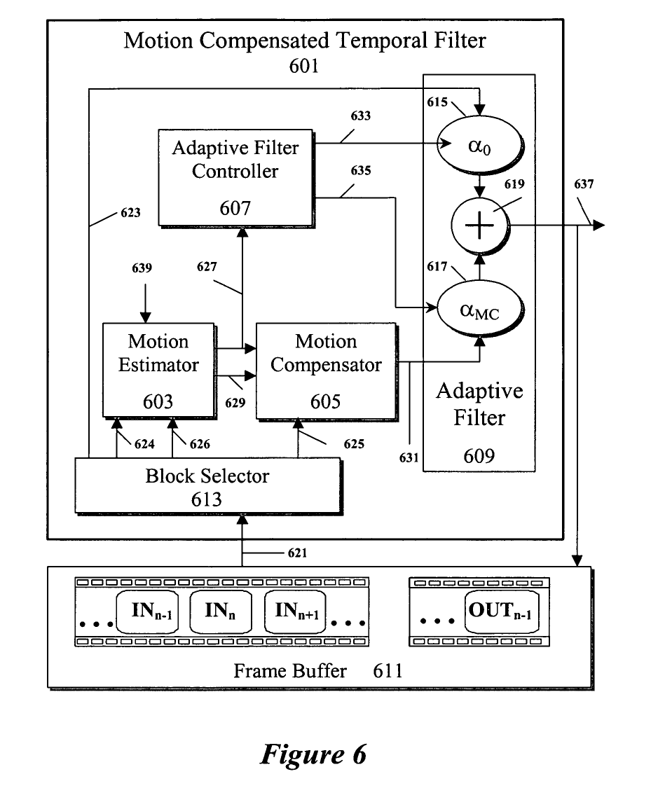

Referring now to FIG. 6, a block diagram of an exemplary Motion Compensated Temporal Filter (MCTF) 601 is illustrated in accordance with an embodiment of the present invention. The MCTF 601 comprises a motion estimator 603, a motion compensator 605, an adaptive filter 609, and an adaptive filter controller 607. A frame buffer 611 may be a memory that stores pixel data during processing. A block selector 613 may be a hardware or software element that directs blocks of pixel data for processing by the MCTF 601.

The block selector 613 directs a current input window 624 and one or more reference pictures 626 to the motion estimator 603. Based on the input 624 and 626, a plurality of candidate motion vectors and quality metrics are generated. These motion vectors may be associated with blocks in an estimation window that extends larger than the current input block.

The window associated with the current input block may be compared to another window that may be temporally located before or after the current picture.

Noise may cause some incorrect motion vectors. It is common for a motion vector to go through the previous picture, the current picture, and the future picture forming a straight line in time and space. If the difference between the residual from the motion vector and the residual from the zero vector is comparable to the noise estimate, the confidence may be lowered. A higher confidence may be associated with motion vectors that are consistent over time. Likewise, the candidate motion vectors for a current block may include the motion vector(s) that were used to predict the reference block(s). This extension of the motion estimation window in time may reduce the occurrence of spurious motion vectors that may arise from random noise.

One or more motion vectors 629 are selected. A selected motion vector 629 is associated with a reference block and a current input block within the current input window 624. If the difference between the residual from the motion vector and the residual from the zero vector is comparable to the noise estimate, motion may not be distinguishable from noise.

The block selector 613 directs the reference block(s) 625 to the motion compensator 605. The motion vector(s) 629 are applied to the reference block(s) 625 to generate one or more motion compensated (MC) blocks. When more than one motion vector 629 is selected, they may be dynamically blended based on quality metrics 627 associated with each motion vector 629 used in the MC block generation. The combination is output 631 to the adaptive filter 609.

The adaptive filter may be implemented as an IIR filter, and FIR filter, or a combination of an IIR and FIR filter. For example within an IIR adaptive filter 609, the MC block or MC block combination 631 is scaled by a value α_{MC} 617. The block selector 613 directs the current block 623 to the adaptive filter 609 where it is scaled by a value α₀ 615. The scaled blocks are combined 619 to generate a current output block 637.

The filter controller 607 adapts α₀ 615 and α_{MC} 617 according to the quality metrics 627. A residual is the difference between the current picture and the motion compensated reference block. By examining the characteristics of the residual, the quality of motion compensation may be determined. If there is content in the residual, this may indicate that the motion compensation is imperfect. By examining the characteristics of the residual, it may be determined that the portion of the output that is motion compensated should be reduced by lowering α_{MC}.

A method of examining the characteristics of the residual may include comparing the magnitude of the residual to a previously obtained noise distribution. If the residual falls within the bounds of the noise, the degree of confidence may be high. If the residual does not fit the noise distribution, α₀ may be adaptively increased toward one, and α_{MC} may be decreased as 1−α₀.

The current output block 637 may be sent to the frame buffer 611. In some configurations, the MCTF 601 may use the current output block 637 as a reference block in a future processing cycle.

In an alternate embodiment of the adaptive filter 609, an FIR filter may be used to average a video signal. The number of taps, N, may be fixed or adapted. The tap weights for an averaging filter may be equal (e.g. 1/N). Alternatively, a lowpass FIR may be designed with tap weights that have non-equal values.

The MCTF output 637 may also be used to predict the current input block 623. A first order IIR filter may be formed by directing the motion estimator 603 and the motion compensator 605 to select and utilize a motion vector associated with a past output block 637.

Since a first order IIR filter only requires one reference, less memory is required for some IIR filter designs. The confidence level 627 associated with the selected motion vector may determine the IIR tap weight, α_{MC}. The scalar value α₀ may be set to 1−α_{MC}.

As α_{MC} is made larger, the time history of the IIR filter could be potentially very long. A long time history may cause motion trails more often than an FIR filter. For example, a moving object having a subtle pattern (e.g. a rug or a couch) that is visibly recognizable in the presence of noise may appear distorted. As a result of the IIR filtering, a residue comprising the pattern may not move with the content, thereby creating a “dirty glass” effect. The content is moving, and the “glass” is not.

To take advantage of both the FIR and the IIR structures in the adaptive filter 609, reference blocks may be selected from the previous input pictures, the future input pictures, and the output of the MCTF. With normalized metric values the motion compensator may dynamically blend an FIR filter with an IIR filter. Prior to blending, motion compensated reference blocks with a high confidence are weighted more than those with a low confidence.

MCTF processing may be generated by the system(s), method(s), or apparatus described in METHOD AND SYSTEM FOR NOISE REDUCTION WITH A MOTION COMPENSATED TEMPORAL FILTER, Ser. No. 60/701,179, filed Jul. 18, 2005 by MacInnis, and incorporated herein by reference for all purposes.

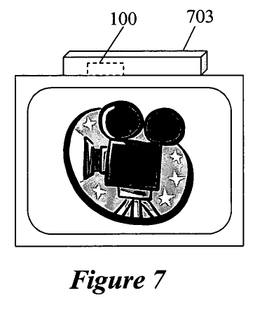

FIG. 7 is a picture of an exemplary video display device 701 containing an MCTF 101 in accordance with an embodiment of the present invention. This video display device may be a set top box that receives analog video. The MCTF 101 reduces noise prior to the display or further processing of the communicated video data.

The embodiments described herein may be implemented as a board level product, as a single chip, application specific integrated circuit (ASIC), or with varying levels of a video processing circuit integrated with other portions of the system as separate components. An integrated circuit may store video data in memory and use an arithmetic logic circuit to perform noise estimation.

The degree of integration of the noise estimation circuitry will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor may be implemented as part of an ASIC device wherein certain functions may be implemented in firmware as instructions stored in a memory. Alternatively, the functions may be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, the invention may be applied to video data associated with a wide variety of analog and/or digital standards in addition to NTSC.

Therefore, it is intended that the present invention not be limited to the particular embodiment disclosed, but that the present invention will include all embodiments falling within the scope of the appended claims.

1. A method for noise estimation, said method comprising:
determining if a plurality of residual values is less than a maximum residual level;
comparing the plurality of residual values to a first threshold, wherein the first threshold is based on a first noise level;
generating a first metric based on said determining and said comparing to the first threshold; and
estimating a noise level based on the first metric.

2. The method of claim 1, wherein the maximum residual level is a function of an expected noise level.

3. The method of claim 1, wherein a residual value is an absolute difference between a first pixel in a first picture and a second pixel in a second picture, and wherein the first pixel and the second pixel have the same spatial location.

4. The method of claim 1, wherein the residual values are located in one or more windows of a picture.

5. The method of claim 1, wherein the first metric is the number of residual values that are less than the first threshold.

6. The method of claim 1, wherein the first metric is the number of residual values that are greater than the first threshold.

7. The method of claim 1, wherein the method further comprises:
comparing the plurality of residual values to a second threshold, wherein the second threshold is based on a second noise level;
generating a second metric based on said determining and said comparing to the second threshold; and
estimating the noise level based on the first metric and the second metric.

8. The method of claim 7, wherein the noise level estimate is interpolated from the first noise level and the second noise level based on the proximity of the first metric and the second metric to a predetermined metric value.

9. The method of claim 7, further comprising:
generating a third threshold based on the noise level estimate; and
comparing a plurality of current residuals to the threshold to determine a noise probability.

10. A system for noise estimation, said system comprising:
a first comparator for determining if a plurality of residual values is less than a maximum residual level;
a second comparator for comparing the plurality of residual values to a first threshold, wherein the first threshold is based on a first noise level;
a first accumulator for generating a first metric based on the determination of the first comparator and comparison of the second comparator; and
a circuit for estimating a noise level based on the first metric.

11. The system of claim 10, wherein the maximum residual level is a function of an expected noise level.

12. The system of claim 10, further comprising:
a residual generator for producing an absolute difference between a first pixel in a first picture and a second pixel in a second picture, thereby generating a residual value in the plurality of residual values.

13. The system of claim 10, wherein the residual values are located in one or more windows.

14. The system of claim 10, wherein the first metric is the number of residual values that are less than the first threshold.

15. The system of claim 10, wherein the first metric is the number of residual values that are greater than the first threshold.

16. The system of claim 10, wherein the system further comprises:
a third comparator for comparing the plurality of residual values to a second threshold, wherein the second threshold is based on a second noise level;
a second accumulator for generating a second metric based on the determination of the first comparator and comparison of the third comparator; and
wherein the circuit estimates the noise level based on the first metric and the second metric.

17. The system of claim 16, wherein the circuit interpolates the noise level estimate from the first noise level and the second noise level based on the proximity of the first metric and the second metric to a predetermined metric value.

18. The system of claim 16, further comprising:
a fourth comparator for comparing a plurality of current residual values to a third threshold, wherein the third threshold is based on the noise level estimate; and
a third accumulator for generating a third metric, thereby indicating a probability of noise in the plurality of current residual values.

19. A video display device comprising:
an integrated circuit comprising:
a memory for storing a plurality of video pictures; and
a circuit connected to the memory, said circuit operable for:
determining if a plurality of residual values, associated with the plurality of video pictures, is less than a maximum residual level;
comparing the plurality of residual values to a first threshold, wherein the first threshold is based on a first noise level;
generating a first metric based on said determining and said comparing to the first threshold; and
estimating a noise level based on the first metric.
